(19) United States
(12) Patent Application Publication
(10) Pub. No.: US 2014/0281002 A1
(43) Pub. Date: Sep. 18, 2014

(54) DEVICES, SYSTEMS, AND METHODS FOR MANAGING AND ADJUSTING ADAPTIVE STREAMING TRAFFIC

(71) Applicant: GENERAL INSTRUMENT CORPORATION, Horsham, PA (US)

(72) Inventor: Wendell Sun, San Diego, CA (US)

(73) Assignee: GENERAL INSTRUMENT CORPORATION, Horsham, PA (US)

(21) Appl. No.: 13/830,898

(22) Filed: Mar. 14, 2013

(51) Int. Cl. H04L 29/06

(52) U.S. Cl. CPC H04L 29/06455
USPC 709/231

(57) ABSTRACT

Systems, devices and methods for managing and adjusting adaptive streaming traffic to optimize fairness are disclosed herein. In one embodiment, a method comprises: receiving a request for a media segment; locating the media segment; determining the bitrate of the requested media segment; and assigning priority information to the media segment, wherein a media segment having a lowest guaranteed bitrate is assigned a higher priority than media segments having higher bitrates.

### FIELD

The disclosure relates generally to the field of data transmission over digital networks, and more specifically to systems, devices and methods for managing and adjusting adaptive streaming traffic to optimize fairness.

### BACKGROUND

By way of background, Internet Protocol Television (“IPTV”) is a system in which digital television service is delivered by using internet protocol over a network infrastructure, which may include delivery by a broadband connection. A general definition of IPTV is television content that, instead of being delivered through traditional broadcast and cable formats, is received by the viewer through the technologies used for computer networks.

For residential users, IPTV is often provided in conjunction with Video on Demand (“VOD”) and may be bundled with internet services such as web access and Voice over Internet Protocol (“VoIP”). In businesses, IPTV may be used to deliver television content over corporate Local Area Networks (“LANs”).

IPTV covers both live TV (e.g., multicasting) as well as stored video (e.g., VOD). The playback of IPTV generally requires either a personal computer or a set-top box connected to a TV. Video content is typically compressed using either a MPEG-2 or a MPEG-4 codec and then sent in a Moving Pictures Expert Group (“MPEG”) transport stream delivered via IP multicast in case of live TV or via IP Unicast in case of VOD. IP multicast or IP multicast protocol is a method in which information or content can be sent to multiple computers at the same time. In IP multicast protocol, each program channel (Pₓ) may be defined as one multicast group, with the client watching the program via Internet Group Management Protocol's (“IGMP's”) join/leave commands. IGMP is described in further detail in IETF Standard, RFC3376, “Internet Group Management Protocol, Version 3”, October 2002, incorporated herein by reference in its entirety.

Generally, in most broadband services, (e.g., Digital Subscriber Line (“DSL”) using twisted telephone wire or cable modem using coaxial cable), the last mile between an edge router and home gateway (hereinafter referred to as “the last mile” or “the last mile bandwidth”) is the bottleneck of bandwidth availability. For example, the AT&T U-verse service is limited to offer only 2 High Definition (“HD”) and 2 Standard Definition (“SD”) channels simultaneously due to DSL bandwidth limitations. This last mile bandwidth availability varies depending upon the physical distance and the signal quality (impairments) from home to home.

Adaptive Bit Rate (ABR) streaming is a technology that combines aspects of streaming and progressive download to provide streaming of media content by breaking the content into a sequence of small HTTP-based file segments, each segment containing a short interval of playback time of a content that is potentially many hours in duration, such as a movie or the live broadcast of a sports event. An ABR player provides streaming playback by requesting an appropriate series of segments as determined by a manifest or playlist file and user requests, such as play, pause, rewind, etc.

### BRIEF SUMMARY

Accordingly, there is provided herein devices, systems and methods that allow for managing and adjusting adaptive streaming traffic to optimize fairness.

In a first aspect, a method is disclosed comprising: receiving a request for a media segment; locating the media segment; determining the bitrate of the requested media segment; and assigning priority information to the media segment, wherein a media segment having a lowest guaranteed bitrate is assigned a higher priority than media segments having higher bitrates. In one embodiment of the first aspect, the method further comprises: transmitting the media segment with priority information to a network. In one embodiment of the first aspect, the media segment request is received from a client. In one embodiment of the first aspect, at least one of the receiving, locating, determining, and assigning is performed at a Hypertext Transfer Protocol (HTTP) server or HTTP proxy server. In one embodiment of the first aspect, the determining the bitrate of the requested media segment comprises checking a manifest file or playlist for bitrate information. In one embodiment of the first aspect, assigning priority information comprises setting a Differentiated Services Code Point (DSCP) field of an Internet Protocol (IP) header for the media segment. In one embodiment of the first aspect, the DSCP field is selected from one of 12 DSCP levels of Assured Forwarding (AF). In one embodiment of the first aspect, assigning priority comprises selecting a DSCP value to represent one of the 12 DSCP levels. In one embodiment of the first aspect, media segments having a lowest guaranteed bitrate are assigned the highest possible priority. In one embodiment of the first aspect, in periods of network congestion, media segments having a higher priority are transmitted before media segments having a lower priority. In one embodiment of the first aspect, if a media segment having a lower priority is not transmitted, a request for the media segment having a lower bitrate may be received and assigned a higher priority. In one embodiment of the first aspect, the media segment having a lower priority is not transmitted because of bandwidth limitations in the network. In one embodiment of the first aspect, the network in an Internet Protocol (IP) network. In one embodiment of the first aspect, the media segment comprises a Hypertext Transfer Protocol (HTTP) adaptive streaming media segment.

In a second aspect, a system is disclosed comprising: a content server having a processor that is configured to: receive a request for a media segment; locate the media segment; determine the bitrate of the requested media segment; and assign priority information to the media segment, wherein a media segment having a lowest guaranteed bitrate is assigned a higher priority than media segments having higher bitrates, and a router having a processor that is configured to: receive the media segment with priority information; and transmit the media segment with priority information to a network. In one embodiment of the second aspect, the content server comprises a Hypertext Transfer Protocol (HTTP) server or HTTP proxy server. In one embodiment of the second aspect, the router comprises a core router or edge router. In one embodiment of the second aspect, said determine the bitrate of the requested media segment comprises checking a manifest file or playlist for bitrate information. In one embodiment of the second aspect, said assign priority information comprises setting a Differentiated Services Code Point (DSCP) field of an Internet Protocol (IP) header for the media segment. In one embodiment of the second aspect, the DSCP field is selected from one of 12 DSCP levels of Assured Forwarding (AF). In one embodiment of the second aspect, said assign priority comprises selecting a DSCP value to represent one of the 12 DSCP levels. In one embodiment of the second aspect, in periods of network congestion, media segments having a higher priority are transmitted before media segments having a lower priority. In one embodiment of the second aspect, the network in an Internet Protocol (IP) network. In one embodiment of the second aspect, the media segment comprises a Hypertext Transfer Protocol (HTTP) adaptive streaming media segment.

### BRIEF DESCRIPTION OF THE DRAWINGS

The details of the present disclosure, both as to its structure and operation, may be understood in part by study of the accompanying drawings, in which like reference numerals refer to like parts. The drawings are not necessarily to scale, emphasis instead being placed upon illustrating the principles of the disclosure.

FIG. 1 is a functional block diagram illustrating an example flow of content in a system from a hypertext transfer protocol (HTTP) server to a plurality of end users or clients in accordance with an embodiment.

FIG. 2 is a functional block diagram illustrating an example structure a program encoded in multiple bit rates in accordance with an embodiment.

FIG. 3 is a functional block diagram illustrating an example process for ingesting, transcoding, segmentation and adaptive streaming in accordance with an embodiment.

FIG. 4 is a functional block diagram illustrating an example flow of data in dynamic adaptive streaming over HTTP (DASH) in accordance with an embodiment.

FIG. 5 is a graph illustrating how one or more greedy clients can impact another client in accordance with an embodiment.

FIG. 6 is a graph illustrating how to allocate bandwidth in accordance with an embodiment.

FIG. 7 is a flow chart illustrating an example process that utilizes DiffServ to optimize fairness in bandwidth allocation in accordance with an embodiment.

### DETAILED DESCRIPTION

In the past few decades, advances in the related fields of video compression and video transmission systems have led to the widespread availability of digital video programs transmitted over a variety of communication systems and networks. Most recently, new technologies have been developed that have allowed television programs to be transmitted as multicast, e.g., IP multicast, digital bit streams of multiplexed video and audio signals delivered to users or client subscribers over packet switched networks.

Adaptive Bit Rate (ABR) streaming is a technology that works by breaking the overall media stream into a sequence of small HTTP-based file downloads, each download loading one short segment of an overall potentially unbounded transport stream. As the stream is played, the client (e.g., the media player) may select from a number of different alternate streams containing the same material encoded at a variety of data rates, allowing the streaming session to adapt to the available data rate. At the start of the streaming session, the player downloads/receives a manifest containing the metadata for the various sub-streams which are available. Since its requests use only standard HTTP transactions, Adaptive Bit Rate streaming is capable of traversing a firewall or proxy server that lets through standard HTTP traffic, unlike UDP-based protocols such as RTP. This also allows a content delivery network (CDN) to readily be implemented for any given stream. ABR streaming methods have been implemented in proprietary formats including HTTP Live Streaming (HLS) by Apple, Inc. and HTTP Smooth Streaming by Microsoft, Inc.

Referring to FIG. 1, an example flow of content in a system 100 from a content server to a plurality of end users or clients is shown. System 100 generally includes a content server (shown as HTTP server 110), a core router 120, an IP distribution network 130, an HTTP proxy server 140, an edge router 150, a home gateway 160, and one or more clients 170a, 170b, 170c, 170d. Also shown is a last mile network 180 located between edge router 150 and home gateway 160. As explained above, the last mile network 180 is generally the bottleneck of bandwidth availability in system 100.

As will be understood by those of skill in the art, HTTP server 110 generally provides the content for system 100. Content may include, for example, audio, video, or other data information provided in, e.g., packet format. Core router 120 may generally receive packet content from HTTP server 110 and reads the address information in the packets to determine their ultimate destination. Then, using information in, e.g., a routing table or routing policy, core router 120 can direct the packets to IP network 130. HTTP server 110 and the method of delivery of its content will be provided below with reference to FIG. 2.

As used herein, a “core router” is an IP router that routes IP single-cast and multi-cast packets in the “core” or of the IP distribution network. Edge routers connect to the core network. Generally, these core routers are managed by “backbone” Wide Area Network (“WAN”) service providers. Interconnection bandwidths may be in the 10's of Gigabits (or much more) and run switching protocols such as Multi-Protocol Label Switching (“MPLS”).

IP network 130 may generally be a network of one or more computers using Internet Protocol for their communication protocol. Similar to core router 120, edge router 150 can direct packets from IP network 130.

In some embodiments, the HTTP proxy server 140 operates as an edge agent of HTTP server 110. HTTP proxy server 140 may be configured to save or cache what HTTP server 110 transmits and avoid duplication of transmissions if more than one client 170 sends a request for content. For example, client 170a may send a request for content X. HTTP proxy server 140 may receive the request first and relay the request to HTTP server 110. HTTP server 110 may reply with content X via HTTP proxy server 140. HTTP proxy server 140 may transmit content X to client 170a, and in some embodiments, may store content X in its cache memory. When client 170b requests the same content X, HTTP proxy server 140 can transmit it immediately, without requesting the content from HTTP server 110.

As used herein, an “edge router” is an IP router that connects access routers to the core network and routes IP single-cast and multi-cast packets in the “edge” of the IP distribution network. Edge routers are generally managed by Internet Service Providers (“ISP”) and may still be considered the WAN part of the network, but in general not the “backbone”. Interconnection bandwidths to access networks vary over a wide range depending on last mile bandwidth and are generally in the Megabit to multi-Megabit range for residential access networks. Bandwidths for enterprises (e.g., commercial business) can be significantly larger.

When transmitting data packets over a network, a last head-end (or central office, point of presence, corporate gateway, or the like) is typically reached, this services a number of users on a data channel, with a head-end router. Such data channels having a single head-end serving a number of users are sometimes referred to as shared data channels. A head-end router is at the “head-end” of a given shared channel and serves as the communications interface with external networks. In this capacity, head-end router routes data packets received to the appropriate user and also prioritizes and schedules data packets for routing to users. In some embodiments, edge router 150 may comprise a head-end router. In some embodiments, core router 120 may comprise a head-end router. In such embodiments, core router 120 may serve as an entry point to the “managed” part of the overall network.

After a data packet is received by the head-end, the head-end router then passes the data onto the appropriate user on the shared channel, e.g., home gateway 160. A bottleneck can occur at this point if the available bandwidth is insufficient to satisfy the demand (e.g., transmission bandwidth on the channel itself or transmission and/or processing bandwidth of the router or head-end), resulting in queuing of “downstream” packets (e.g., packets destined for a user of the shared channel serviced by the head-end).

As an example, in the AT&T Uverse^{SM} service, there is usually a head-end router and a kiosk on the street with VDSL2 DSL transmitters. It is the bandwidth between the head-end router and the gateway in the home that, in general, is the congested part of the network.

For example, a plurality of users may be attached to a given head-end, which itself is coupled to IP network 130. One of the users may request a program from HTTP server 110. This program may be routed through the IP network 130 in the form of packets, and ultimately delivered to the user's own head-end. The head-end then typically immediately routes the packets to the recipient/user with the head-end router, if possible, or queues them in a buffer (typically, a first-in, first out (FIFO) buffer) if other packets are currently occupying the shared channel.

In some embodiments, home gateway 160 is a residential local area network (“LAN”) for communication between digital devices typically deployed in the home, e.g., personal computers and accessories (e.g., printers and mobile computing devices). It should be appreciated that home gateway 160 may include all or a portion of digital devices within a user's home. Alternatively, home gateway 160 may be defined to include a broader range of devices, such as a set of homes within a community, etc.

Referring back to Clients 1-4 170a-d, as shown, Client 1 170a and Client 2 170b are part of the same LAN. For example, Client 1 170a and Client 2 170b may be a computer and a set top box for television operating within a first user's home. Client 3 170c may be a set top box operating within a second user's home and Client 4 170d may be a set top box operating within a third user's home.

Because the last mile bandwidth availability varies depending on the physical distance, signal quality from home to home (e.g., Client 1-2 170a-b and Client 3 170c and Client 4 170d), and number of active users, it may be desirable to adjust the content compression parameters accordingly to provide the committed service to all homes. However, when more bandwidth is available, it would be preferable to deliver improved quality to active users by further adjusting the content compression. This may be achieved, in some embodiments, through adaptive switching of content prepared with multiple bit rates. Alternately, in an example, when Clients 2-4 170b-d are not active, Client 1 170a may utilize the whole pipe solely. Adaptive switching of content to a higher bit rate for Client 1 170a may be performed in such an instance.

Referring now to FIG. 2, a functional block diagram illustrating an example structure of a program encoded in multiple bit rates is shown. In FIG. 2, an MPEG-2 transport packet having a length of 188 bytes is shown. A desirable feature of MPEG-2 encoding is its ability to remove redundancy, not only within a frame, but also among a group of frames. Generally, MPEG-2 uses three frame types (I, P, and B) to represent video. A group of pictures (“GOP”) setting defines the pattern of the three frame types used.

The intra-frame (“I-frame”) is also known as the key frame. Every GOP includes one I-frame. The I-frame is the only MPEG-2 frame type which can be fully decompressed without any reference to frames that precede or follow it. It is also the most data-heavy, requiring the most bandwidth or bitrate. If a user wants to place an I-frame at a scene change or some other specific frame location, the user must manually set it. This is known as a forced I-frame.

The predicted-frame (“P-frame”) is encoded from a “predicted” picture based on the closest preceding I- or P-frame. P-frames typically require much less bandwidth or bitrate than do I-frames because they reference a preceding I- or P-frame in the GOP.

Both I-frames and P-frames are also known as reference frames, because a bi-directional-frame (“B-frame”) may refer to either one or both frame types. The B-frame is encoded from an interpolation of succeeding and preceding reference frames, either I-frame or P-frame. B-frames are the most storage-efficient MPEG-2 frame type, requiring the least amount of bandwidth or bitrate.

As is known to those of ordinary skill in the art, the use of adaptive streaming may prepare content e.g., video content, such that the same content is encoded in multiple bit rate streams. Generally, the higher the bit rate, the better the content quality. Any suitable generic video encoding process, e.g., software and hardware, known by one skilled in the art may be utilized. In some embodiments, the encoding is performed by multi-bit rate transcoder and the processed media contents are stored in the HTTP server box.

In FIG. 2, a program X 200 is shown as being encoded in multiple bit rates. In this particular example, program X 200 may have a high bit rate structure stream 210 and a low bit rate structure stream 250. Consequently, for each program Pn there will be PnH and PnL structure (e.g., for program 1, there will be P1H, P1L; for program 2 there will be P2H, P2L, etc.).

In some embodiments, in the encoding process, the GOP/I-frame alignment is maintained amongst the streams 210, 250. In some embodiments, the I-frame is an instantaneous decoder refresh (“IDR”) frame. An IDR frame is a special kind of I-frame used in MPEG-4 AVC encoding. Generally, frames following an IDR frame may not refer back to frames preceding the IDR frame. For seamless switch from one bit rate to another, an IDR frame may be desirable. As used herein, “alignment amongst streams” means the IDR frames with same presentation timestamp (“PTS”) on all bit rate streams represent identical scene content.

In the example of FIG. 2, in high bit rate data structure stream 210 there are three packets shown 220, 230 and 240. Each packet 220-240 includes a similar structure, with an IP or User Datagram Protocol (“UDP”) header portion 232 and the transport packet portion 234, being shown for packet 230. Similarly, in low bit rate data structure stream 250, there are two packets shown 260 and 270. Each packet 220-240 includes a similar structure, with an IP or User Datagram Protocol (“UDP”) header portion 272 and the transport packet portion 274, being shown for packet 270.

Because GOP/I-frame alignment is maintained amongst the streams 210, 250, the client can seamlessly switch from one bit rate stream to another when playing back if switching occurs at a suitable or predetermined switching point. In some embodiments, a suitable switching point may be at a defined boundary of the closed GOP/I-frame (e.g., at the beginning of the header portion 232, 272), shown as reference numeral 280. In some embodiments, a switching identifier or switching point may be carried as the first media frame in a media payload packet in an IP packet.

In some embodiments, if the HTTP server 110 is streaming content to a first user at a high bit rate, e.g., stream 210, and a second user requests bandwidth, the second user is allocated bandwidth if it is available after the first user is allocated its bandwidth. The client 170 decides which bit rate it should ask for, so if there is available bandwidth to accommodate a higher bit rate, the client 170 will be allocated the higher bit rate. With adaptive streaming, a user or client 170 can view better video when bandwidth is sufficient, (e.g., less program channels or better last mile connection), or get more channels with low bit rate (but still acceptable) program quality.

Referring now to FIG. 3, content prepared by and/or delivered from HTTP server 110 may be classified as HTTP adaptive streaming. Adaptive streaming operates by dynamically adjusting the play-out rate to stay within the actual network throughput to a given endpoint, without the need for rebuffering. So, if the network throughput suddenly drops, the picture may degrade but the end user still sees a picture.

Although adaptive streaming was originally developed for over-the-top video applications over unmanaged networks, it also brings advantages to managed network applications. For example, during periods of network congestion, operators can set session management polices to permit a predefined level of network over-subscription rather than blocking all new sessions (such as when last mile bandwidth availability is too limited to allow another client to join). This flexibility will become more important as subscribers demand higher quality feeds (e.g., 1080p and 4K).

As used herein, HTTP adaptive streaming is the generic term for various implementations: Apple HTTP Live Streaming (HLS), Microsoft IIS Smooth Streaming, Adobe HTTP Dynamic Streaming (HDS), and MPEG DASH.

Although each of the various implementations of HTTP adaptive streaming is different, they all have a set of common properties. For example, still referring to FIG. 3, source content 310 is transcoded in parallel at multiple bit rates (e.g., multi-rate coding) in a transcoding process 320. Each bit rate is called a profile or representation. As shown, the source content 310 may comprise media content such as live source content and/or file source content. For example, the file source content may include movies, TV programs, etc. The live source content may include live streaming format, such as a live broadcast of a sports program or game.

Encoded content is divided into fixed duration segments (e.g. chunks) in a segmentation process 330. The segments or chunks are typically between two and 10 seconds in duration, although they may be longer or shorter. In some embodiments, shorter segments reduce coding efficiency while larger segments impact speed to adapt to changes in network throughput.

A manifest file is created and updated as necessary to describe the encoding rates and URL pointers to segments in a manifest file creation process 340. As used herein, a manifest file or playlist describes how content is prepared, how many different encoding bitrates, and for each bitrate stream, how long a segment is, and where to obtain each segment of each bitrate stream.

In some embodiments, the client uses HTTP to fetch segments from the network, buffer them and then decode and play them. The client may utilize one or more algorithms designed to select the optimum profile so as to maximize quality without risking buffer underflow and stalling (e.g., rebuffering) of the play-out. For example, each time the client fetches a segment, it may choose the profile based on the measured time to download the previous segment.

While HTTP adaptive streaming has been discussed generally, it should be appreciated that there has been a push for standardization of HTTP adaptive streaming given that there various implementations, as provided above. For example, Moving Picture Experts Group (MPEG) Dynamic Adaptive Streaming over HTTP (MPEG-DASH) may become a popular choice. While HLS uses MPEG-2 transport stream format, Smooth Streaming and MPEG-DASH use MPEG-4 Part 14. Smooth Streaming and MPEG-DASH include full support for subtitling and trick modes (e.g., fast-forward, etc.), whereas HLS is limited in this regard. MPEG-DASH enables common encryption, which simplifies the secure delivery of content from multiple rights holders and multiple devices.

Another difference is the way in which MPEG-DASH and Smooth Streaming play-out is controlled when transmission path conditions change. For example, HLS uses manifest files that are effectively a playlist identifying the different segments so when path impairment occurs, the selection of the uniform resource locator (URL) from the manifest file adapts so that the lower bit-rate segments are selected. In Smooth Streaming, the client uses time stamps to identify the segments needed, thus gaining efficiencies. Both HLS and Smooth Streaming handle files in subtly different ways, each claiming some efficiency advantage over the other. Both use HTTP, which has the ability to traverse firewalls and network address translation.

There are currently a number of initiatives aimed at large parts of the overall solution for streaming video. MPEG has standardized a Manifest File (MF), a Delivery Format (DF), and a means for easy conversion from/to existing File Formats (FF) and Transport Streams (TS), as illustrated in FIG. 4. Specifically, MPEG-DASH has the potential to simplify and converge the delivery of IP video and provide a rich and enjoyable user experience.

Regardless of the type of HTTP adaptive streaming being implemented, HTTP adaptive streaming clients generally implement a “greedy” algorithm, in which they will always seek to achieve the maximum bite rate available (e.g., by adjusting the content compression to the clients). This greediness can lead to instability, oscillation and unfairness, where some clients will win and others will lose in times of network congestion.

For example, referring back to FIG. 1, HTTP adaptive streaming is unicast video delivery from HTTP server 110 to each client 170. When many clients run simultaneously, they are competing for bandwidth resources, especially when all requesting clients are located after the last mile 180.

Currently, and in the foreseeable future, each client will run or operate independently of other clients. Without coordination, a greedy client (e.g., implementing a greedy algorithm) or a newly launched client can cause total bandwidth requirement exceeds in the pipe (e.g., the total bandwidth allowed in the transmission conduit at the last mile 180. In this congested situation, edge router 150 may begin to drop packets. If the higher bitrates' stream is slowed due to dropped packets, the client 170 switches to lower bitrates, but if the lowest bitrates' steam is slowed, the client play-out may be stalled (e.g., for rebuffering).

FIG. 5 is a graph illustrating how one or more greedy clients can impact another client in accordance with an embodiment. In FIG. 5, three clients, A, B, and C are shown along with their bandwidth usage over time. The total available bandwidth for the 3+ clients is set at 6 Mbps. From looking at the graph, it is readily apparent that clients A and B are using much more bandwidth at any given time than client C. Without coordination, each client switches individually (e.g., requests bandwidth), and sometimes one of the clients freezes because of unfairness of traffic control. In fact, at time T_{F}, client C is shown to freeze (e.g., rebuffering) because there is not enough bandwidth to support client C at 1.5 Mpbs (because client A is operating at 3 Mpbs and client B is operating at 2 Mpbs).

FIG. 6 is a graph illustrating how to allocate bandwidth in accordance with an embodiment. In FIG. 6, three clients, A, B, and C are shown along with their bandwidth usage over time. Once again, the total available bandwidth for the 3+ clients is set at 6 Mbps. However, there is no freezing of any client because of greediness. This bandwidth allocation may be achieved using a method that presumes the minimum guaranteed bandwidth is greater than the sum of bit rate of all concurrent streams running in their lowest bitrate. In other words, ensuring that at least the minimum bitrate for all streams operating will be met, results in all clients being allocated some bandwidth (e.g., at least the minimum bitrate). As shown, at time Tₛ, client C has requested bandwidth and begins streaming data. Also at time Tₛ, clients A and B show a reduction in allocated bandwidth, to accommodate for client A's allocation.

In order to ensure that the minimum guaranteed bandwidth is provided to all current and future clients, a method of traffic control may be implemented. In some embodiments, an underlying assumption may be made—for any possible congested bandwidth pipe, the minimum guaranteed bandwidth is greater than the sum of the bitrate required by all concurrent streams running at their lowest bitrate.

In some embodiments, traffic control may be implemented using differentiated services (DiffServ), which is broadly used for quality of service (QoS) on modern IP networks. Generally speaking, DiffServ is a computer networking architecture that specifies a simple, scalable and coarse-grained mechanism for classifying and managing network traffic and providing QOS. DiffServ can, for example, be used to provide low-latency to critical network traffic such as voice or streaming media while providing simple best-effort service to non-critical services such as web traffic or file transfers. DiffServ uses a 6-bit Differentiated Services Field (DS field) in the IP header for packet classification purposes. There are a total of 64 priority levels in DiffServ.

DiffServ operates on the principle of traffic classification, where each data packet is placed into a limited number of traffic classes, rather than differentiating network traffic based on the requirements of an individual flow. Each router on the network is configured to differentiate traffic based on its class or assigned priority level. Each traffic class can be managed differently, ensuring preferential treatment for higher-priority traffic on the network.

While DiffServ does recommend a standardized set of traffic classes, the DiffServ architecture does not incorporate predetermined judgments of what types of traffic should be given priority treatment; DiffServ simply provides a framework to allow classification and differentiated treatment.

In some embodiments, traffic control may be implemented by assigning a higher delivery priority to the IP packets of lower bitrate streams at the HTTP server. In such embodiments, the edge router that supports the DiffServ QoS drops packets of higher bitrate stream first when bandwidth congestion occurs, thus “forcing” the client that runs the higher bitrate stream to switch to a lower bitrate. Referring back to FIG. 6, such a switching is shown to occur at time Tₛ. Additionally, in such embodiments, the client that runs on the lowest bitrate receives the highest priority treatment (e.g., the last client to be slowed down or rebuffered because of dropped packets).

In some embodiments, priority may be assigned using the 12 Differentiated Services Code Point (DSCP) levels of Assured Forwarding (AF) behavior defined in RFC 2597 and RFC 3260. Assured forwarding may allow the operator to provide assurance of delivery as long as the traffic does not exceed some subscribed rate (e.g., the minimum guaranteed bandwidth). Traffic that exceeds the subscription rate faces a higher probability of being dropped if congestion occurs.

The AF behavior group defines four separate AF classes with Class 4 having the highest priority. Within each class, packets are given a drop precedence (high, medium or low). The combination of classes and drop precedence yields twelve separate DSCP encodings from AF11 through AF43 as shown in Table 1.

TABLE 1
Assured Forwarding (AF) Behavior Group

| | Class 1 | | | Class 4 |
|---|---|---|---|---|
| | (lowest) | Class 2 | Class 3 | (highest) |
| Low Drop | AF11 | AF21 | AF31 | AF41 |
| | (DSCP 10) | (DSCP 18) | (DSCP 26) | (DSCP 34) |
| Med Drop | AF12 | AF22 | AF32 | AF42 |
| | (DSCP 12) | (DSCP 20) | (DSCP 28) | (DSCP 36) |
| High Drop | AF13 | AF23 | AF33 | AF43 |
| | (DSCP 14) | (DSCP 22) | (DSCP 30) | (DSCP 38) |

Some measure of priority and proportional fairness is defined between traffic in different classes. Should congestion occur between classes, the traffic in the higher class is given priority. Rather than using strict priority queuing, more balanced queue servicing algorithms such as fair queuing or weighted fair queuing (WFQ) are likely to be used. If congestion occurs within a class, the packets with the higher drop precedence are discarded first. To prevent issues associated with tail drop, more sophisticated drop selection algorithms such as random early detection (RED) may be used.

Additionally, besides the bitrate stream when assigning a DSCP, other factors may be considered to maintain a suitable traffic flow. For example, preference on one program/content over another, preference on a premium user, preference on a specific time, etc. may be used as such an additional factor(s).

Referring now to FIG. 7, a flow chart illustrating an example process 700 that utilizes DiffServ to optimize fairness in bandwidth allocation is shown. At block 710, HTTP server 110 or HTTP proxy 140 (hereinafter collectively referred to as “HTTP server system” for clarity) receive a request for a media segment from a client 170. HTTP server system thereafter locates the media segment at block 720. At block 730, HTTP server system reads the bitrate of the requested segment by checking the manifest file or playlist. At block 740, HTTP server system assigns or sets the DSCP field of the IP header of the media segment with priority information. For example, for the media segment with the lowest bitrate, the priority information is set at a higher (or highest) priority. For a media segments with bitrates higher than the lowest bitrate, the priority information is set at a normal or lower priority. In some embodiments, the priority assigned to the media segments scales with the bitrate demands (e.g., the lowest bitrate is assigned a priority of “1”, the medium bitrate is assigned a priority of “2”, and the highest bitrate is assigned a priority of “3”). At block 750, HTTP server system sends the media segment with the priority information to the IP Network. While not shown, the core router 120 and/or edge router 150 thereafter receive(s) the media segment and assigns out the available bandwidth to the requesting client.

It should be appreciated that the media segments will be treated differently (e.g., according to priority information) by core router 120 and/or edge router 150. As shown in FIG. 6, the media segment with the lowest bit rate will not be dropped in a period of network congestion because the client is guaranteed to receive the media segment at the lowest bitrate.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent exemplary embodiments of the invention and are therefore representative of the subject matter which is broadly contemplated by the present invention. It is further understood that the scope of the present invention fully encompasses other embodiments and that the scope of the present invention is accordingly limited by nothing other than the appended claims.

We claim:

1. A method, comprising:
receiving a request for a media segment;
locating the media segment;
determining the bitrate of the requested media segment; and
assigning priority information to the media segment, wherein a media segment having a lowest guaranteed bitrate is assigned a higher priority than media segments having higher bitrates.

2. The method of claim 1, further comprising:
transmitting the media segment with priority information to a network.

3. The method of claim 1, wherein the media segment request is received from a client.

4. The method of claim 1, wherein at least one of the receiving, locating, determining, and assigning is performed at a Hypertext Transfer Protocol (HTTP) server or HTTP proxy server.

5. The method of claim 1, wherein the determining the bitrate of the requested media segment comprises checking a manifest file or playlist for bitrate information.

6. The method of claim 1, wherein assigning priority information comprises setting a Differentiated Services Code Point (DSCP) field of an Internet Protocol (IP) header for the media segment.

7. The method of claim 6, wherein the DSCP field is selected from one of 12 DSCP levels of Assured Forwarding (AF).

8. The method of claim 7, wherein assigning priority comprises selecting a DSCP value to represent one of the 12 DSCP levels.

9. The method of claim 1, wherein media segments having a lowest guaranteed bitrate are assigned the highest possible priority.

10. The method of claim 2, wherein, in periods of network congestion, media segments having a higher priority are transmitted before media segments having a lower priority.

11. The method of claim 10, wherein if a media segment having a lower priority is not transmitted, a request for the media segment having a lower bitrate may be received and assigned a higher priority.

12. The method of claim 11, wherein the media segment having a lower priority is not transmitted because of bandwidth limitations in the network.

13. The method of claim 1, wherein the network in an Internet Protocol (IP) network.

14. The method of claim 1, wherein the media segment comprises a Hypertext Transfer Protocol (HTTP) adaptive streaming media segment.

15. A system, comprising:
a content server having a processor that is configured to:
receive a request for a media segment;
locate the media segment;
determine the bitrate of the requested media segment; and
assign priority information to the media segment, wherein a media segment having a lowest guaranteed bitrate is assigned a higher priority than media segments having higher bitrates, and
a router having a processor that is configured to:
receive the media segment with priority information; and
transmit the media segment with priority information to a network.

16. The system of claim 15, wherein the content server comprises a Hypertext Transfer Protocol (HTTP) server or HTTP proxy server.

17. The system of claim 15, wherein the router comprises a core router or edge router.

18. The system of claim 15, wherein said determine the bitrate of the requested media segment comprises checking a manifest file or playlist for bitrate information.

19. The system of claim 15, wherein said assign priority information comprises setting a Differentiated Services Code Point (DSCP) field of an Internet Protocol (IP) header for the media segment.

20. The system of claim 19, wherein the DSCP field is selected from one of 12 DSCP levels of Assured Forwarding (AF).

21. The system of claim 20, wherein said assign priority comprises selecting a DSCP value to represent one of the 12 DSCP levels.

22. The system of claim 15, wherein, in periods of network congestion, media segments having a higher priority are transmitted before media segments having a lower priority.

23. The system of claim 15, wherein the network in an Internet Protocol (IP) network.

24. The system of claim 15, wherein the media segment comprises a Hypertext Transfer Protocol (HTTP) adaptive streaming media segment.
